(19) United States
(12) Patent Application Publication
(10) Pub. No.: US 2021/0232871 A1
(43) Pub. Date: Jul. 29, 2021

(54) OBJECT DETECTION USING MULTIPLE SENSORS AND REDUCED COMPLEXITY NEURAL NETWORKS

(71) Applicant: Optimum Semiconductor Technologies Inc., Tarrytown, NY (US)

(72) Inventors: Sabin Daniel IANCU, Pleasantville, NY (US); John GLOSSNER, Nashua, NH (US); Beinan WANG, White Plains, NY (US)

(73) Assignee: Optimum Semiconductor Technologies Inc., Tarrytown, NY (US)

(21) Appl. No.: 17/258,015

(22) PCT Filed: Jun. 20, 2019
(86) PCT No.: PCT/US2019/038254

§ 371 Date: Jan. 5, 2021

Related U.S. Application Data
(60) Provisional application No. 62/694,096, filed on Jul. 5, 2018.

(51) Int. Cl. G06K 9/62; G06T 7/50; G06K 9/46; G06K 9/20; G06N 3/04

(52) U.S. Cl. CPC G06K 9/6288; G06T 7/50; G06K 9/4647; G06K 9/2054; G06K 9/6256; G06T 2207/20081; G06N 3/0454; G06T 2207/10028; G06T 2207/10016; G06T 2207/20084; G06K 9/4652

(57) ABSTRACT

A system and method relating to object detection using multiple sensor devices include receiving a range data comprising a plurality of points, each of plurality of points being associated with an intensity value and a depth value, determining, based on the intensity values and depth values of the plurality of points, abounding box surrounding a cluster of points among the plurality of points, receiving a video image comprising an array of pixels, determining a region in the video image corresponding to the bounding box, and applying a first neural network to the region to determine an object captured by the range data and the video image.

### CROSS-REFERENCE TO RELATED APPLICATION

This application claims priority to U.S. Provisional Application 62/694,096 filed Jul. 5, 2018, the content of which is incorporated by reference in its entirety.

### TECHNICAL FIELD

The present disclosure relates to detecting objects from sensor data, and in particular, to a system and method for object detection using multiple sensors and reduced complexity neural networks.

### BACKGROUND

Systems including hardware processors programmed to detect objects in an environment have a wide range of industrial applications. For example, an autonomous vehicle may be equipped with sensors (e.g., Light Detection and Ranging (Lidar) sensor and video cameras) to capture sensor data surrounding the vehicle. Further, the autonomous vehicle may be equipped with a processing device to execute executable code to detect the objects surrounding the vehicle based on the sensor data.

Neural networks can be employed to detect objects in the environment. The neural networks referred to in this disclosure are artificial neural networks which may be implemented on electrical circuits to make decisions based on input data. A neural network may include one or more layers of nodes, where each node may be implemented in hardware as a calculation circuit element to perform calculations. The nodes in an input layer may receive input data to the neural network. Nodes in a layer may receive the output data generated by nodes in a prior layer. Further, the nodes in the layer may perform certain calculations and generate output data for nodes of the subsequent layer. Nodes of the output layer may generate output data for the neural network. Thus, a neural network may contain multiple layers of nodes to perform calculations propagated forward from the input layer to the output layer. Neural networks are widely used in object detection.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system to detect objects using multiple sensor data and neural networks according to an implementation of the present disclosure.

FIG. 2 illustrates a system that combine Lidar sensor and image sensors using neural networks to detect objects according to an implementation of the present disclosure.

FIG. 3 illustrates an exemplary convolutional neural network.

FIG. 4 depicts a flow diagram of a method to use fusion-net to detect objects in images according to an implementation of the present disclosure.

FIG. 5 depicts a flow diagram of a method that uses multiple sensor devices to detect objects according to an implementation of the disclosure.

FIG. 6 depicts a block diagram of a computer system operating in accordance with one or more aspects of the present disclosure.

### DETAILED DESCRIPTION

A neural network may include multiple layers of nodes including an input layer, an output layer, and hidden layers between the input layer and the output layer. Each layer may include nodes associated with node values calculated from a prior layer through edges connecting nodes between the present layer and the prior layer. The calculations are propagated from the input layer through the hidden layers to the output layer. Edges may connect the nodes in a layer to nodes in an adjacent layer. The adjacent layer can be a prior layer or a following layer. Each edge may be associated with a weight value. Therefore, the node values associated with nodes of the present layer can be a weighed summation of the node values of the prior layer.

One type of the neural networks is the convolutional neural network (CNN) where the calculation performed at the hidden layers can be convolutions of node values associated with the prior layer and weight values associated with edges. For example, a processing device may apply convolution operations to the input layer and generate the node values for the first hidden layer connected to the input layer through edges, and apply convolution operations to the first hidden layer to generate node values for the second hidden layer, and so on until the calculation reaches the output layer. The processing device may apply a soft combination operation to the output data and generate a detection result. The detection result may include the identities of the detected objects and their locations.

The topology and the weight values associated with edges are determined in a neural network training phase. During the training phase, training input data may be fed into the CNN in a forward propagation (from the input layer to the output layer). The output data of the CNN may be compared to the training output data to calculate an error data. Based on the error data, the processing device may perform a backward propagation in which the weight values associated with edges are adjusted according to a discriminant analysis. This process of forward propagation and backward propagation may be iterated until the error data meet certain performance requirements in a validation process. The CNN then can be used for object detection. The CNN may be trained for a particular class of objects (e.g., human objects) or multiple classes of objects (e.g., cars, pedestrians, and trees).

The operations of the CNN include performing filter operations on the input data. The performance of the CNN can be measured using a peak energy to noise ratio (PNR) where the peak represents a match between the input data and the pattern represented by the filter parameters. Since the filter parameters are trained using the training data including the one or more classes of objects, the peak energy may represent the detection of an object. The noise energy may be a measurement of noise component in the environment. The noise can be ambient noise. A higher PNR may indicate a CNN with better performance When the CNN is trained for multiple classes of objects and the CNN is to detect a particular class of objects, the noise component may include the ambient noise as well as objects belonging to classes other than the target class, resulting that the PNR may include the ratio of the peak energy over the sum of the noise energy and the energy of other classes. The presence of other classes of objects may cause the deterioration of the PNR and the performance of the CNN.

For example, the processing device may apply a CNN (a complex one trained for multiple classes of objects) to the images captured by high-resolution video cameras to detect objects in the images. The video cameras can have 4K resolution including images having an array of 3,840 by 2,160 pixels. The input data can be the high-resolution images, and can further include multiple classes of objects (e.g., pedestrians, cars, trees etc.). To accommodate the high-resolution images as the input data, the CNN can include a complex network of nodes and a large number of layers (e.g., more than 100 layers). The complexity of the CNN and the presence of multiple classes of objects in the input data may negatively impact the PNR, thus negatively impacting the performance of the CNN.

To overcome the above-identified and other deficiencies of complex CNN, implementations of the present disclosure provide a system and method that may use multiple, specifically-trained, compact CNNs to detect the objects based on sensor data. In one implementation, a system may include a Lidar sensor and a video camera. The sensing elements (e.g., pulsed laser detection sensing elements) in the Lidar sensor may be calibrated with the image sensing elements of the video camera so that each pixel in the Lidar image captured by the Lidar may be uniquely mapped to a corresponding pixel in the video image captured by the video camera. The mapping indicates that the two mapped pixels may be derived from an identical point in the surrounding environment of the physical world. A processing device, coupled to the Lidar sensor and the video camera, may perform further processing of the sensor data captured by the Lidar sensor and the video camera.

In one implementation, the processing device may calculate cloud of points from the raw Lidar sensor data. The cloud of points represents 3D locations in a coordinate system of the Lidar sensor. Each point in the cloud of points may correspond to a physical point in the surrounding environment detected by the Lidar sensor. The points in the cloud of points may be grouped into different clusters. A cluster of the points may correspond to one object in the environment. The processing device may apply filter operations and cluster operations to the cloud of points to determine a bounding box surrounding a cluster on the 2D Lidar image captured by the Lidar sensor. The processing device may further determine an area on the image array of the video camera that corresponds to the bounding box in the Lidar image. The processing device may extract the area as a region of interest (ROI) which can be much smaller than the size of the whole image array. The processing device may then feed the region of interest to a CNN to determine whether the region of interest contains an object. Since the region of interest is much smaller than the whole image array, the CNN can be a compact neural network with much less complexity compared to the CNN trained for the full video image. Further, because the compact CNN processes a region of interest containing one object, the PNR of the compact CNN is less likely degraded by interfering objects that belong to other classes. Thus, implementations of the disclosure may improve the accuracy of the object detection.

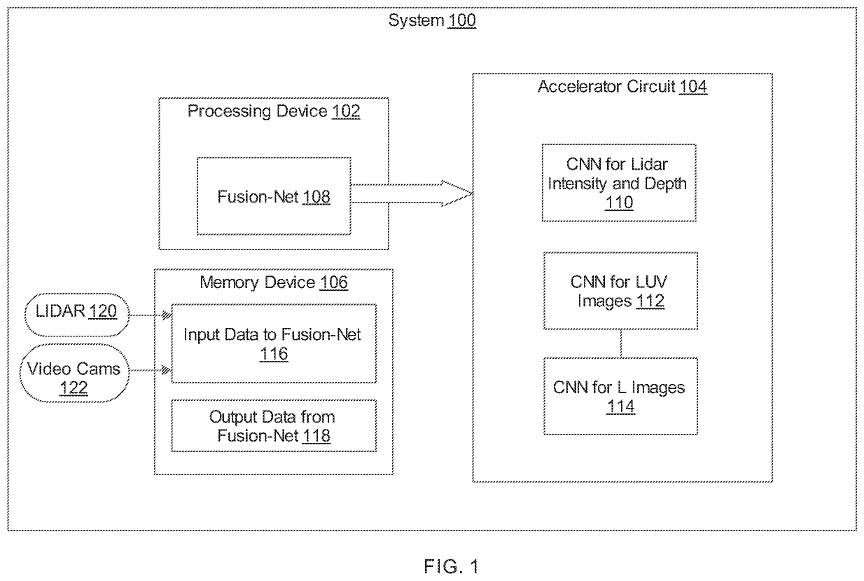

FIG. 1 illustrates a system 100 to detect objects using multiple sensor data and neural networks according to an implementation of the present disclosure. As shown in FIG. 1, system 100 may include a processing device 102, an accelerator circuit 104, and a memory device 106. System 100 may optionally include sensors such as, for example, Lidar sensors and video cameras. System 100 can be a computing system (e.g., a computing system onboard autonomous vehicles) or a system-on-a-chip (SoC). Processing device 102 can be a hardware processor such as a central processing unit (CPU), a graphic processing unit (GPU), or a general-purpose processing unit. In one implementation, processing device 102 can be programmed to perform certain tasks including the delegation of computationally-intensive tasks to accelerator circuit 104.

Accelerator circuit 104 may be communicatively coupled to processing device 102 to perform the computationally-intensive tasks using the special-purpose circuits therein. The special-purpose circuits can be an application specific integrated circuit (ASIC), a field programmable gate array (FPGA), a digital signal processor (DSP), network processor, or the like. In one implementation, accelerator circuit 104 may include multiple calculation circuit elements (CCEs) that are units of circuits that can be programmed to perform a certain type of calculations. For example, to implement a neural network, CCE may be programmed, at the instruction of processing device 102, to perform operations such as, for example, weighted summation and convolution. Thus, each CCE may be programmed to perform the calculation associated with a node of the neural network; a group of CCEs of accelerator circuit 104 may be programmed as a layer (either visible or hidden layer) of nodes in the neural network; multiple groups of CCEs of accelerator circuit 104 may be programmed to serve as the layers of nodes of the neural networks. In one implementation, in addition to performing calculations, CCEs may also include a local storage device (e.g., registers) (not shown) to store the parameters (e.g., synaptic weights) used in the calculations. Thus, for the conciseness and simplicity of description, each CCE in this disclosure corresponds to a circuit element implementing the calculation of parameters associated with a node of the neural network. Processing device 102 may be programmed with instructions to construct the architecture of the neural network and train the neural network for a specific task.

Memory device 106 may include a storage device communicatively coupled to processing device 102 and accelerator circuit 104. In one implementation, memory device 106 may store input data 116 to a fusion-net 108 executed by processing device 102 and output data 118 generated by the fusion-net. The input data 116 can be sensor data captured by sensors such as, for example, Lidar sensor 120 and video cameras 122. Output data can be object detection results made by fusion-net 108. The objection detection results can be the classification of an object captured by sensors 120, 122.

In one implementation, processing device 102 may be programmed to execute fusion-net code 108 that, when executed, may detect objects based on input data 116 including both Lidar data and video image. Instead of utilizing a neural network that detects objects based on full-sized and full-resolution images captured by video cameras 122, implementations of fusion-net 108 may employ the combination of several reduced-complexity neural networks, where each of the reduced-complexity neural networks target a region within a full-sized and full-resolution image to achieve object detection. In one implementation, fusion-net 108 may apply a convolutional neural network (CNN) 110 to Lidar sensor data to detect bounding boxes surrounding regions of potential objects, extract regions of interests from the video image based on the bounding boxes, and then apply one or more CNNs 112, 114 to regions of interest to detect objects within the bounding boxes. Due to CNN 110 is trained to determine bounding boxes, the computational complexity of CNN 110 can be much less than those CNNs designed for object detection. Further, because the sized of the bounding boxes is typically much smaller than the full resolution video image, CNNs 112, 114 may be less affected by noise and objects of other classes, thus achieving better PNR for the objection detection. Further, the segmentation of the regions of interest prior to applying the CNN 112, 114 may further improve the detection accuracy.

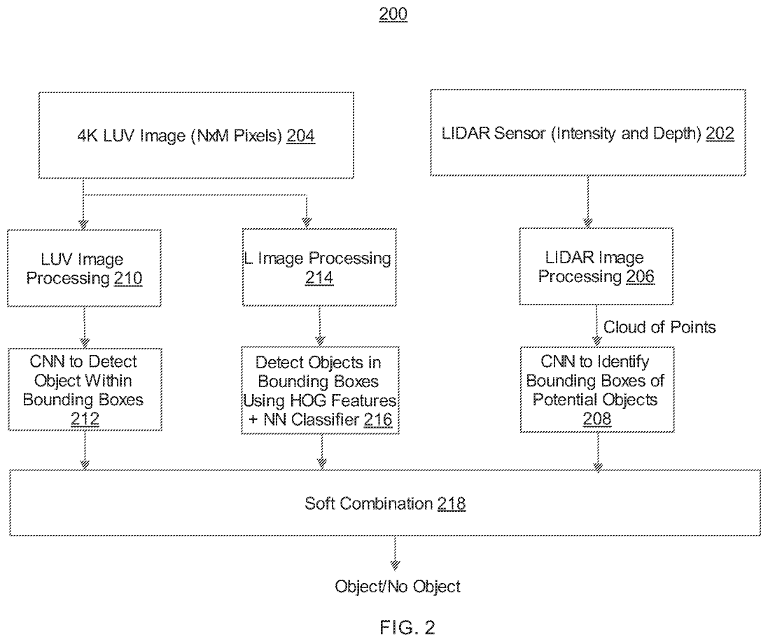

FIG. 2 illustrates a fusion-net 200 that uses multiple reduced-complexity neural networks to detect objects according to an implementation of the present disclosure. Fusion-net 200 may be implemented as a combination of software and hardware on processing device 102 and accelerator circuit 104. For example, fusion-net 200 may include code executable by processing device 102 that may utilize multiple reduced-complexity CNNs implemented on accelerator circuit 104 to perform object detection. As shown in FIG. 2, fusion-net 200 may receive Lidar sensor data 202 captured by Lidar sensors and receive video images 204 captured by video cameras. A Lidar sensor may send out laser beams (e.g., infrared light beams). The laser beams may be bounced back from the surfaces of objects in the environment. The Lidar may measure intensity values and depth values associated with the laser beams bounced back from the surfaces of objects. The intensity values reflect the strengths of the return laser beams, where the strengths are determined, in part, by the reflectivity of the surface of the object. The reflectivity pertains to the wavelength of the laser beams and the composition of the surface materials. The depth values reflect the distances from surface points to the Lidar senor. The depths values can be calculated based on the phase difference between the incident and the reflected laser beams. Thus, the raw Lidar sensor data may include points distributed in a three-dimensional physical space, where each point is associated with a pair of values (intensity, depth). Laser beams may be deflected by bouncing off multiple surfaces before they are received by the Lidar sensor. The deflections may constitute the noise components in the raw Lidar sensor data.

Fusion-net 200 may further include Lidar image processing 206 to filter out the noise component in the raw Lidar sensor data. The filter applied to the raw Lidar sensor data can be suitable types of smooth filters such as, for example, low-pass filters, median filters etc. These filters can be applied to the intensity values and/or the depth values. The filters may also include beamformers that may remove the reverberances of the laser beams.

The filtered Lidar sensor data may be further processed to generate clouds of points. The clouds of points are clusters of 3D points in the physical space. The clusters of points that may represent the shapes of objects in the physical space. Each cluster may correspond to a surface of an object. Thus, each cluster of points can be a potential candidate for an object. In one implementation, the Lidar senor data may be divided into subranges according to the depth value (or the “Z” values). Assuming that objects are separated and located at different ranges of distances, each subrange may correspond to a respective cloud of points. For each subrange, fusion-net 200 may extract the intensity values (or the “I” values) associated with the points within the subrange. The extraction may result in multiple two-dimensional Lidar intensity images, each Lidar intensity image corresponding to a particular of depth subrange. The intensity images may include an array of pixels with values representing intensities. In one implementation, the intensity values may be quantized to a pre-determined number of intensity levels. For example, each pixel may use eight bits to represent 256 levels of intensity values.

Fusion-net 200 may further convert each of the Lidar intensity images into a respective bi-level intensity image (binary image) by thresholding, where each of the Lidar intensity images may corresponding to a particular depth subrange. This process is referred to as binarizing the Lidar intensity images. For example, fusion-net 200 may determine a threshold value. The threshold value may represent the minimum intensity value that an object should have. Fusion-net 200 may compare the intensity values of intensity images against the threshold value, and set with any intensity values above (or equal to) the threshold value to “1” and any intensity values below the threshold to “0.” As such, each clusters of high intensity values may correspond to a blob of the high value in the binarized Lidar image.

Fusion-net 200 may use convolutional neural network (CNN) 208 to detect a two-dimensional bounding box surrounding each cluster of points in each of the Lidar intensity image. The structure of CNNs is discussed in detail in the later sections. In one implementation, CNN 208 may have been trained on training data that include the objects at known positions. CNN 208 after training may identify bounding boxes surrounding potential objects.

These bounding boxes may be mapped to corresponding regions in video images which may be served as the regions for object detection. The mapping relation between the sensor array of the Lidar sensor and the image array of the video camera may have been pre-determined based on the geometric relationships between the Lidar sensor and the video sensor. As shown in FIG. 2, fusion-net 200 may receive video images 204 captured by video cameras. The video cameras may have been calibrated with the Lidar sensor with a certain mapping relation, and therefore, the pixel locations on the video images may be uniquely mapped to the intensity images of Lidar sensor data. In one implementation, the video image may include an array of N by M pixels, wherein N and M are integer values. In the HDTV standard video format, each pixel is associated with a luminance value (L) and color values U and V (the scaled values between the L, and blue and red values). In other implementations, the pixels of video images may be represented with values defined in other color representation schemes such as, for example, RGB (red, green, blue). These color representation schemes can be mapped to the LUV representation using linear or non-linear transformations. Thus, any suitable color representation formats may be used to represent the pixel values in this disclosure. For the conciseness of description, the LUV representation is used to describe implementations of the disclosure.

In one implementation, instead of detecting objects from the full resolution video image (N×M pixels), fusion-net 200 may limit the area for the objection detection to the bounding boxes identified by CNN 208 based on Lidar sensor data. The bounding boxes are commonly much smaller than the full resolution video image. Each bounding box likely contains one candidate for one object.

Fusion-net 200 may first perform image processing on the LUV video image 210. The image processing may include performing low-pass filter on the LUV video image and then decimating the low-passed video image. The decimation of the low-passed video image may reduce the resolution of the video image by a factor (e.g., 4, 8, or 16) in both x and y directions. Fusion-net 200 may apply the bounding boxes to the processed video image to identify regions of interest in which objects may exist. For each identified region of interest, fusion-net 200 may apply a CNN 212 to determine whether the region of interest contains an object. CNN 212 may have been trained on training data to detect objects in video images. The training data may include images that have been labeled as different classes of objects. The training results are a set of features representing the object.

When applying CNN 212 to regions of interest in the video image, CNN 212 may calculate an output representing the correlations between the features of the region of interests and the features representing a known class of objects. A peak in the correlation may represent the identification of an object belonging to the class. In one implementation, CNN 212 may include a set of compact neural networks, each compact neural network being trained for a particular object. The region of interest may be fed into different compact neural networks of CNN 212 for identifying different classes of objects. Because CNN 212 is trained to detect particular classes of objects within a small region, the PNR of CNN 212 is less likely impacted by interclass object interferences.

Instead of using LUV video images as the input, implementations of the disclosure may use the luminance (L) values of the video image as the input. Using L values alone may further simplify the calculation. As shown in FIG. 2, fusion-net 200 may include L image processing 214. Similar to the LUV image processing 210, the L image processing 214 may also include low-pass filtering and decimating the L image. Fusion-net 200 may apply the bounding boxes to the processed L image to identify regions of interest in which objects may exist. For each identified region of interest in the L image, fusion-net 200 may apply a histogram oriented gradients (HOG) filter. The HOG filter may count occurrences of gradient orientations within a region of interest. The counts of gradients at different orientations form a histogram of these gradients. Since the HOG filter operates in the local region of interest, it may be invariant to geometric and photometric transformations. Thus, features extracted by the HOG filter may be substantially invariant in the presence of geometric and photometric transformations. The application of the HOG filter may further improve the detection results.

Fusion-net 200 may train CNN 216 based on the HOG features. In one implementation, CNN 216 may include a set of compact neural networks, each compact neural network being trained for a particular class of objects base on HOG features. Because each neural network in CNN 216 is trained for a particular class of objects, these compact neural network may detect the classes of objects with high PNR.

Fusion-net 200 may further include a soft combination layer 218 that may combine the results from CNN 208, 212, 216. The soft combination layer 218 may include a softmax function. Fusion-net 200 may use the softmax function to determine the class of object based on results from CNN 208, 212, 216. The softmax may choose the result of the network associated with the higher likelihood of object detection.

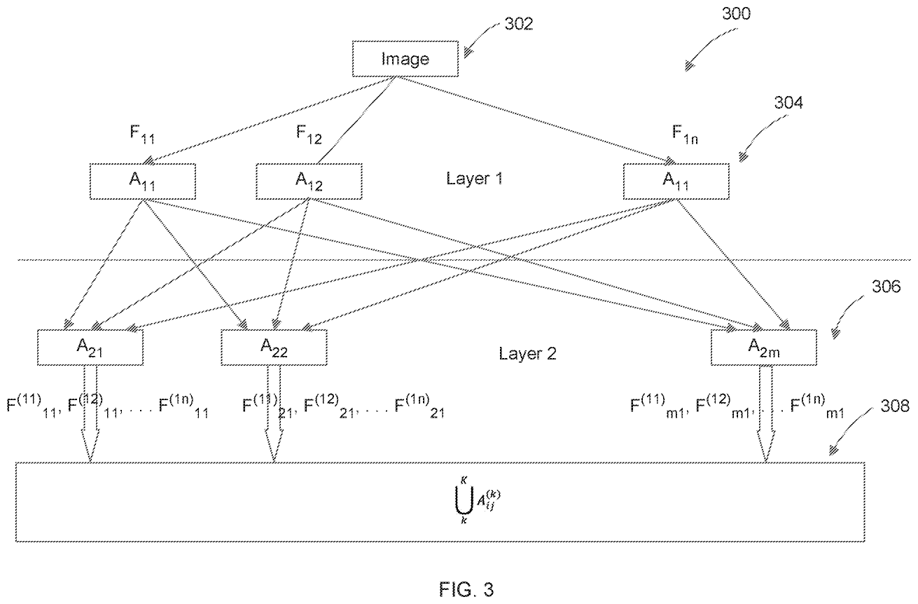

Implementations of the disclosure may use convolutional neural network (CNN) or any suitable forms of neural networks for objection detection. FIG. 3 illustrates an exemplary convolutional neural network 300. As shown in FIG. 3, CNN 300 may include an input layer 302. The input layer 302 may receive input sensor data such as, for example, Lidar sensor data and/or video image. CNN 300 may further include hidden layers 304, 306, and an output layer 308. The hidden layers 304, 306 may include nodes associated with feature values (A₁₁, A₁₂, . . . , A₁ₙ, . . . , A₂₁, A₂₂, . . . A₂ₘ). Nodes in a layer (e.g., 304) may be connected to nodes in an adjacent layer (e.g., 306) by edges. Each edge may be associated with a weight value. For example, edges between the input layer 302 and the first hidden layer 304 are associated with weight values (F₁₁, F₁₂, . . . , F₁ₙ); edges between the first hidden layer 304 and the second hidden layer 306 are associated with weight values F⁽¹¹⁾₁₁, F⁽¹²⁾₁₁, F⁽¹ⁿ⁾₁₁; edges between the hidden layer 306 and the output layer are associated with weight values F⁽¹¹⁾ₘ₁, F⁽¹²⁾ₘ₂, . . . , F⁽¹ⁿ⁾ₘ₁. The feature values (A₂₁, A₂₂, . . . , A₂ₘ) at the second hidden layer 306 may be calculated as follows:

$$A * {A}_{2 i} = A * {\sum }_{k = 1}^{n} {F}_{1 k} * {F}_{1 i}^{( 1 k )} , i = 1 , 2 , … , q$$

where A represents the input image, and * is the convolution operator. Thus, the feature map in the second layer is the sum of the correlations calculated from the first layer, and the feature map for each layer may be similarly calculated. The last layer can be expressed as a string of all rows concatenated into a large vector or as an array of tensors. The last layer may be calculated as follows:

$$A * {\sum }_{i}^{m} {M}_{i} = φ ( \{ {F}_{rq}^{( l , m )} \} ) ,$$

where Mᵢ is the features of the last layer, and {F_{rq}^{(l,m)}} is the list of all features after training. The input image A is correlated with the list of all features. In one implementation, multiple compact neural networks are used for object detection. Each of the compact neural networks corresponds to one corresponding class of objects. The object localization may be achieved through analysis of Lidar sensor data, and the object detection is confined to regions of interest.

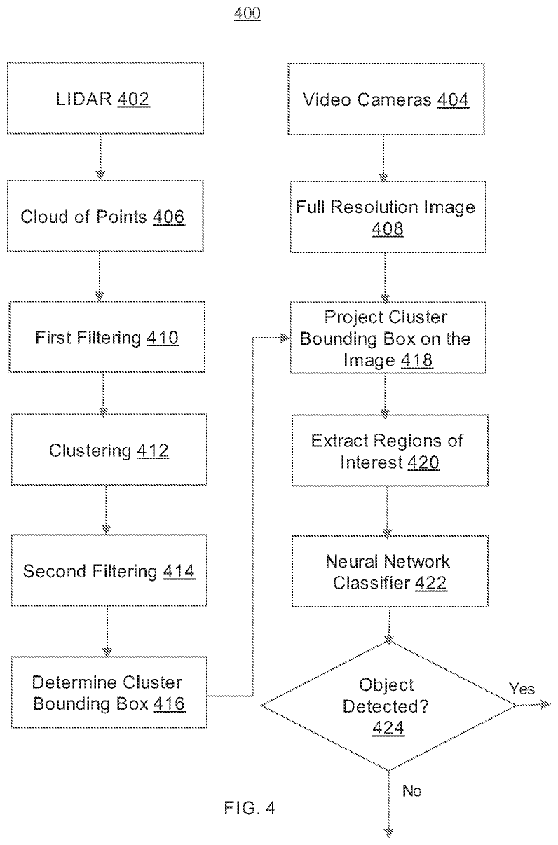

FIG. 4 depicts a flow diagram of a method 400 to use fusion-net to detect objects in images according to an implementation of the present disclosure. Method 400 may be performed by processing devices that may comprise hardware (e.g., circuitry, dedicated logic), computer readable instructions (e.g., run on a general purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processing device 102 executing fusion-net 108 and accelerator circuit 104 supporting CNNs as shown in FIG. 1.

Referring to FIG. 4, at 402, Lidar sensor may capture Lidar sensor data which include information of objects in the environment. At 404, video cameras may capture the video images of the environment. The Lidar sensor and the video cameras may have been calibrated in advance so that a position on the Lidar sensor array may be uniquely mapped to a position on the video image array.

At 406, the processing device may process Lidar sensor data to clouds of points where each point may be associated with an intensity value and a depth value. Each cloud may correspond to an object in the environment. At 410, the processing device may perform a first filter operation on the clouds of points to separate the clouds based on the depth values. At 412, as discussed above, the depth values may be divided into subranges and the clouds may be separated by clustering points in different subranges. At 414, the processing device may perform a second filter operation. The second filter operation may include binarize the intensity values for different subranges. Within each depth subrange, the intensity value above or equal to a threshold value is set to “1,” and the intensity value below the threshold value is set to “0.”

At 416, the processing device may further process the binarized intensity Lidar images to determine bounding boxes for the clusters. Each bounding box may surround the region of a potential object. In one implementation, a first CNN may be used to determine the bounding boxes as discussed above.

At 408, the processing device may receive the full resolution image from video cameras. At 418, the processing device may project the bounding boxes determined at 416 to the video image based on pre-determined mapping relation between the Lidar sensor and the video camera. These bounding boxes may specify the potential regions of objects in the video image.

At 420, the processing device may extract these regions of interest based on the bounding boxes. These regions of interest can be input to a set of compact CNNs that each is trained to detect a particular class of objects. At 422, the processing device may apply these class-specific CNNs to these regions of interest to detect whether there is an object of a particular class in the region. At 424, the processing device may determine, based on a soft combining (e.g., softmax function) to determine whether the region contains an object. Because method 400 uses localized regions of interest containing one object per region and uses class-specific compact CNNs, the detection rate is higher due to the improved PNR.

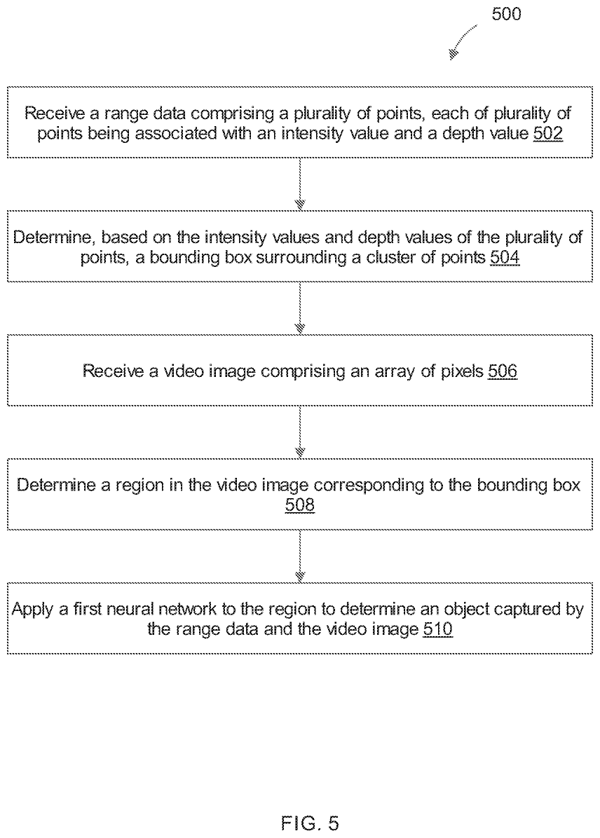

FIG. 5 depicts a flow diagram of a method 500 that uses multiple sensor devices to detect objects according to an implementation of the disclosure.

At 502, the processing device may receive a range data comprising a plurality of points, each of plurality of points being associated with an intensity value and a depth value.

At 504, the processing device may determine, based on the intensity values and depth values of the plurality of points, a bounding box surrounding a cluster of points.

At 506, the processing device may receive a video image comprising an array of pixels.

At 508, the processing device may determine a region in the video image corresponding to the bounding box.

At 510, the processing device may apply a first neural network to the region to determine an object captured by the range data and the video image.

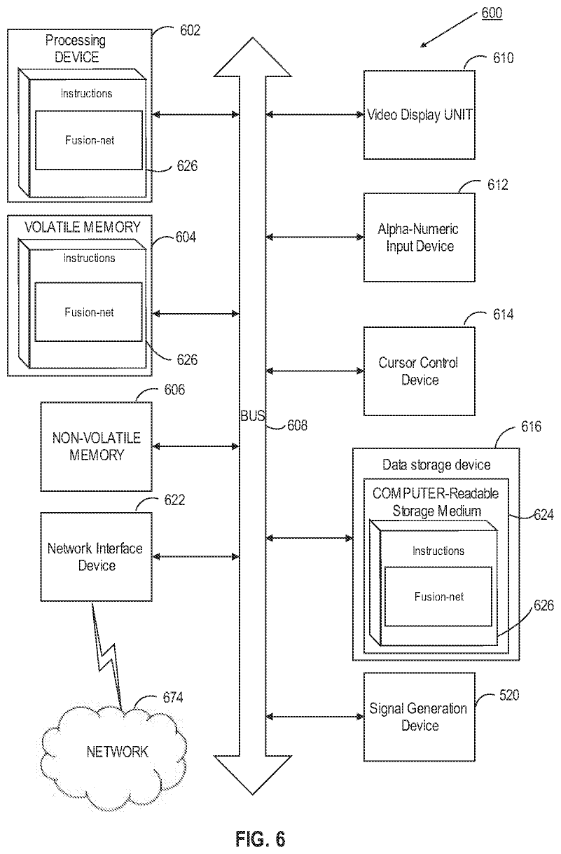

FIG. 6 depicts a block diagram of a computer system operating in accordance with one or more aspects of the present disclosure. In various illustrative examples, computer system 600 may correspond to the system 100 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions of the constructor of fusion-net 108 of FIG. 1 for implementing method 400 or method 500.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method for detecting objects using multiple sensor devices, comprising:
receiving, by a processing device, a range data comprising a plurality of points, each of plurality of points being associated with an intensity value and a depth value;
determining, by the processing device based on the intensity values and depth values of the plurality of points, a bounding box surrounding a cluster of points among the plurality of points;
receiving, by the processing device, a video image comprising an array of pixels;
determining, by the processing device, a region in the video image corresponding to the bounding box; and
applying, by the processing device, a first neural network to the region to determine an object captured by the range data and the video image.

2. The method of claim 1, wherein the multiple sensor devices comprise a range sensor to capture the range data and a video camera to capture the video image.

3. The method of any of claim 1, wherein determining, by the processing device based on the intensity values and depth values of the plurality of points, a bounding box surrounding a cluster of points further comprises:
separating the plurality of points into layers according to depth values associated with the plurality of points; and
for each of the layers,
converting intensity values associated with the plurality of points into binary values based on a predetermined threshold value; and
applying a second neural network to the binary values to determine the bounding box.

4. The method of claim 3, wherein at least one of the first neural network or the second neural network is a convolutional neural network.

5. The method of claim 3, wherein each of the array of pixel is associated with a luminance value (L) and two color values (U, V).

6. The method of claim 5, wherein determining, by the processing device, a region in the video image corresponding to the bounding box further comprises:
determining a mapping relation between a first coordinate system specifying a sensor array of the range sensor and a second coordinate system specifying an image array of the video camera; and
determining the region in the video image based on the bounding box and the mapping relation, wherein the region is smaller than the video image at a full resolution.

7. The method of claim 5, wherein applying a first neural network to the region to determine an object captured by the range data and the video image comprises:
applying the first neural network to the luminance values (I) and two color values (U, V) associated with pixels in the region.

8. The method of claim 5, wherein applying a first neural network to the region to determine an object captured by the range data and the video image comprises:
applying a histogram oriented gradients (HOG) filter to luminance values associated with pixels in the region; and
applying the first neural network to the HOG-filtered luminance values associated with the pixels in the region.

9. A system, comprising:
sensor devices;
a storage device for storing instructions;
a processing device, communicatively coupled to the sensor devices and the storage device, for executing the instructions to:
receive a range data comprising a plurality of points, each of plurality of points being associated with an intensity value and a depth value;
determine, based on the intensity values and depth values of the plurality of points, a bounding box surrounding a cluster of points among the plurality of points;
receive a video image comprising an array of pixels;
determine a region in the video image corresponding to the bounding box; and
apply a first neural network to the region to determine an object captured by the range data and the video image.

10. The system of claim 9, wherein the sensor devices comprise a range sensor to capture the range data and a video camera to capture the video image.

11. The system of claim 9, wherein to determine, based on the intensity values and depth values of the plurality of points, a bounding box surrounding a cluster of points, the processing device is further to:
separate the plurality of points into layers according to depth values associated with the plurality of points; and
for each of the layers,
convert intensity values associated with the plurality of points into binary values based on a predetermined threshold value; and
apply a second neural network to the binary values to determine the bounding box.

12. The system of claim 11, wherein at least one of the first neural network or the second neural network is a convolutional neural network.

13. The system of claim 11, wherein each of the array of pixel is associated with a luminance value (L) and two color values (U, V).

14. The system of claim 13, wherein to determine a region in the video image corresponding to the bounding box further comprises, the processing device is further to
determine a mapping relation between a first coordinate system specifying a sensor array of the range sensor and a second coordinate system specifying an image array of the video camera; and
determine the region in the video image based on the bounding box and the mapping relation, wherein the region is smaller than the video image at a full resolution.

15. The system of claim 13, wherein to appl a first neural network to the region to determine an object captured by the range data and the video image, the processing device is to: apply the first neural network to the luminance values (I) and two color values (U, V) associated with pixels in the region.

16. The system of claim 15, to appl a first neural network to the region to determine an object captured by the range data and the video image, the processing device is to:
apply a histogram oriented gradients (HOG) filter to luminance values associated with pixels in the region; and
apply the first neural network to the HOG-filtered luminance values associated with the pixels in the region.

17. A non-transitory machine-readable storage medium storing instructions which, when executed, cause a processing device to perform operations for detecting objects using multiple sensor devices, the operations comprising:
receiving, by the processing device, a range data comprising a plurality of points, each of plurality of points being associated with an intensity value and a depth value;
determining, by the processing device based on the intensity values and depth values of the plurality of points, a bounding box surrounding a cluster of points among the plurality of points;
receiving, by the processing device, a video image comprising an array of pixels;
determining, by the processing device, a region in the video image corresponding to the bounding box; and
applying, by the processing device, a first neural network to the region to determine an object captured by the range data and the video image.

18. The non-transitory machine-readable storage medium of claim 18, wherein the multiple sensor devices comprise a range sensor to capture the range data and a video camera to capture the video image.

19. The non-transitory machine-readable storage medium of claim 17, wherein determining, by the processing device based on the intensity values and depth values of the plurality of points, a bounding box surrounding a cluster of points further comprises:
separating the plurality of points into layers according to depth values associated with the plurality of points; and
for each of the layers,
converting intensity values associated with the plurality of points into binary values based on a predetermined threshold value; and
applying a second neural network to the binary values to determine the bounding box.

20. The non-transitory machine-readable storage medium of claim 18, wherein at least one of the first neural network or the second neural network is a convolutional neural network.
